(19) United States
(12) Patent Application Publication
(10) Pub. No.: US 2025/0232168 A1
(43) Pub. Date: Jul. 17, 2025

(54) AutoSpec

(71) Applicant: Jaxon, Inc., Boston, MA (US)

(72) Inventors: Gregory HARMAN, Castro Valley, CA (US); Robert Jones, Williamsburg, VA (US)

(73) Assignee: Jaxon, Inc., Boston, MA (US)

(21) Appl. No.: 18/413,670

(22) Filed: Jan. 16, 2024

(51) Int. Cl. G06F 30/27

(52) U.S. Cl. CPC G06N 3/08; G06N 20/00

(57) ABSTRACT

Apparati and methods for designing and evaluating machine learning (ML) and other computer systems at the metadata level. A unique graphical meta-level formalism for representing these systems is employed, which supports both human and machine evaluation, simulation, and evolution of alternate architectures and designs. Each graph comprises a plurality of nodes and a plurality of edges connecting the nodes. Each node represents an operation that produces at least one outbound feature, while each edge represents a set of features. The graph (or a subgraph within the graph) can be reconfigured by applying a transform operation to the graph or subgraph.

### RELATED APPLICATION

This patent application claims the priority benefit of commonly owned U.S. provisional patent application 63/455,895 filed Mar. 30, 2023 entitled “AutoSpec”.

### STATEMENT OF GOVERNMENTAL INTEREST

The invention described herein is a subject invention under U.S. government contract FA864922P0658 awarded by USAF Research Lab AFRL SBRK. As such, the U.S. government has certain rights in this invention.

### TECHNICAL FIELD

This invention, which we refer to as “AutoSpec”, pertains to the field of modeling and manipulating computer systems, in particular systems embodying artificial intelligence (AI) components, such as machine learning (ML) components.

### BACKGROUND ART

The field of artificial intelligence (AI) has been marked by an overwhelming emphasis on model architectures and tuning. Researchers and practitioners have invested significant time and resources into developing increasingly complex models, fine-tuning hyperparameters, and squeezing out incremental improvements in performance. In recent years, there has been a growing recognition of the need for more data-centric approaches to AI, which prioritize the quality and quantity of data used to train models. However, this new recognition of data-centric AI still fails to address two practical considerations for applying machine learning (ML) models to real-world problems:
1. Data cannot be properly selected and prepared until the exact task the dataset is intended to address has been specified. High-quality annotations are useful only if they are appropriate annotations to solve the problem at hand.
2. Practical AI systems are seldom comprised of just standalone ML models. Rather, practical AI systems typically require numerous models working together, possibly in conjunction with other software components. In such a system, there is almost always more than one way to define the functionality and other characteristics of the individual components in order to achieve the overall objective. The optimum specification for any single model, or its supporting data, cannot be known out of context of the overall system.

Given the time, expense, and expertise required to prepare data and train competitive ML models, it is common for a too-early annotation effort to unnecessarily constrain a model. This makes it much more difficult to subsequently adjust other parts of the system, and provides a disincentive to further alter the cognizant model, even if overall system performance indicates that such adjustment would be advantageous.

It is an object of the present invention to remedy these problems inherent in the prior art, by providing a high level (meta level) graphical technique for modeling and manipulating complex computer systems.

### SUMMARY OF THE INVENTION

An embodiment of the present invention comprises a graph for representing a computer system. The graph comprises a plurality of nodes and a plurality of edges connecting the nodes. Each node represents an operation that produces at least one outbound feature, while each edge represents a set of features. The graph can be reconfigured by applying a transform operation to the graph.

### BRIEF DESCRIPTION OF THE DRAWINGS

These and other more detailed and specific objects and features of the present invention are more fully disclosed in the following specification, reference being had to the accompanying drawings, in which:

FIG. 1 is a draftsperson's rendition of a computer screenshot illustrating a graphical representation of a sample AutoSpec graph.

FIG. 2 is a draftsperson's rendition of a computer screenshot of a prototype implementation constructed by Applicant, showing the effects of a sample AutoSpec Transform.

### DETAILED DESCRIPTION OF PREFERRED EMBODIMENTS

AutoSpec is, at its heart, a graphical formalism for representing and reasoning about data systems-in particular, those data systems with machine learning models as components—at the metadata level. Specifically, AutoSpec's definition of metadata focuses on representing a system architecture as a metadata flow graph of salient features. In this graph, edges represent feature sets; and nodes represent models, data sources, and other software components that manipulate or transform feature sets. It is important to note that representations of nodes are defined in terms of what features the nodes consume and produce at the metadata level, and not the specific implementation details of the lower-level data processing steps that are needed in order to make the nodes function properly. In other words, nodes merely define the what, not the how.
Feature sets (edges)-Because AutoSpec works with metadata, connections (edges) between nodes are schematic definitions of datasets rather than actual data. In other words, the edges of an AutoSpec graph represent columns of a customary dataframe or data table, and not the rows. Here we use the nomenclature features to represent these schematic fields, consistent with conventional terminology for the inputs to machine learning models. It is also our observation that the inference(s) (output) produced by a model (node) can then be consumed by a subsequent model (node), allowing the term feature to be semantically correct for the outputs of nodes as well as for the inputs of nodes.
Feature producers (nodes)—Each node in an AutoSpec graph represents an operation (which may or may not be a ML model) that optionally consumes inbound features and produces one or more output features. Each node may be provided with optional constraints on the type, grouping, values, statistical properties, etc. of features produced or consumed by the node. Examples of feature producers (nodes) include:
   Classifiers—Classifiers consume input features and produce a discrete category of output features. Note that we do not specify the underlying mechanism of the classifier. The underlying mechanism may include techniques comprising at least one of deep neural networks, decision trees, sets of hard-coded if-then rules, regular expressions, and/or other predetermined algorithms.
   Generators—within this abstraction, data streams (such as internet feeds), active databases, API (Application Programming Interface) interactions, and static files are all characterized as generators. A generator consumes no input features, but produces one or more output features.
   Regressors—similar to classifiers, regressors consume input features. In contrast to classifiers, regressors produce a continuous numerical output instead of a discrete category of output features.
   Data Sink Nodes—nodes that consume features but do not produce any output features.

There are many feature producers (nodes) other than those listed above that can be used within the spirit and scope of the present invention. Additionally, the feature producers (nodes) can be subclassed. For example, there may be specific types of classifiers and/or specific types of regressors.

The graphical formalism of AutoSpec can be expressed in any graphical language. Applicant's implementations have utilized both JSON and Python data structures to express AutoSpec's graphical formalism. Specific formats consumable by open source libraries such as NetworkX and Apache Gremlin/TinkerPop can also be used.

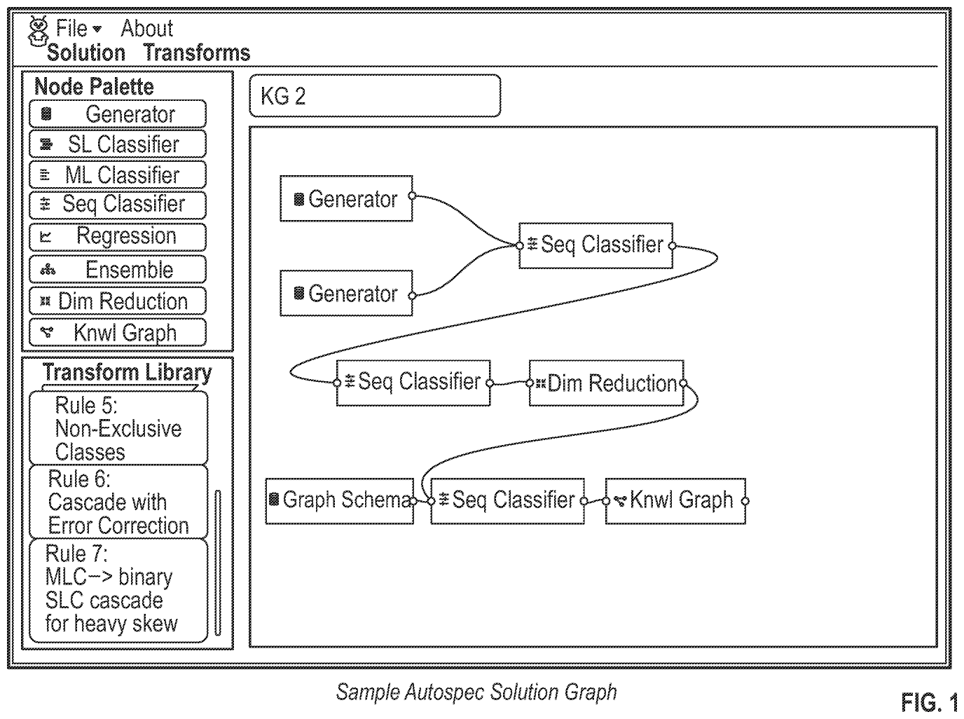

FIG. 1 is a draftsperson's rendition of a computer screenshot illustrating an AutoSpec graphical representation that Applicant has implemented in a working prototype. The right hand side of FIG. 1 identifies a number of feature producers (nodes) and interconnecting feature set flows (edges), constituting a small example of a multi-component machine learning system. The left hand side of FIG. 1 gives a number of mouse-clickable examples of nodes and Transforms that can be selected by the user.

In the example illustrated in FIG. 1, one Generator might represent textual data read from a fixed file, and the other Generator might represent an active database view. The Sequential Classifiers may, for example, summarize the data and subsequently redact sensitive information. The Dimension Reduction node would then project each example into a vector space, supporting the subsequent loading into a structured Knowledge Graph.

An advantage of the present invention is that graph formalism is well-defined, and supports algorithmic reasoning about the target system and alterations to the system via Transforms. In the present invention, Transforms are implemented as graph rewrites. These Transforms are pattern matches of a subgraph (portion of the original graph) based on node type, topography, and metadata (such as the constraints on input and output features mentioned above). When a pattern is matched, the Transform replaces the pattern with an alternative subgraph pattern of connected nodes.

These Transforms, or graph rewritings, can be constrained to different equivalency guarantees in terms of system behavior and output features. This allows a user to conduct an assisted search of a logical solution space to discover different system designs (as represented by graph rewrites) that offer either fully equivalent or nearly equivalent solutions, with different tradeoffs in logical form, fit, or function.

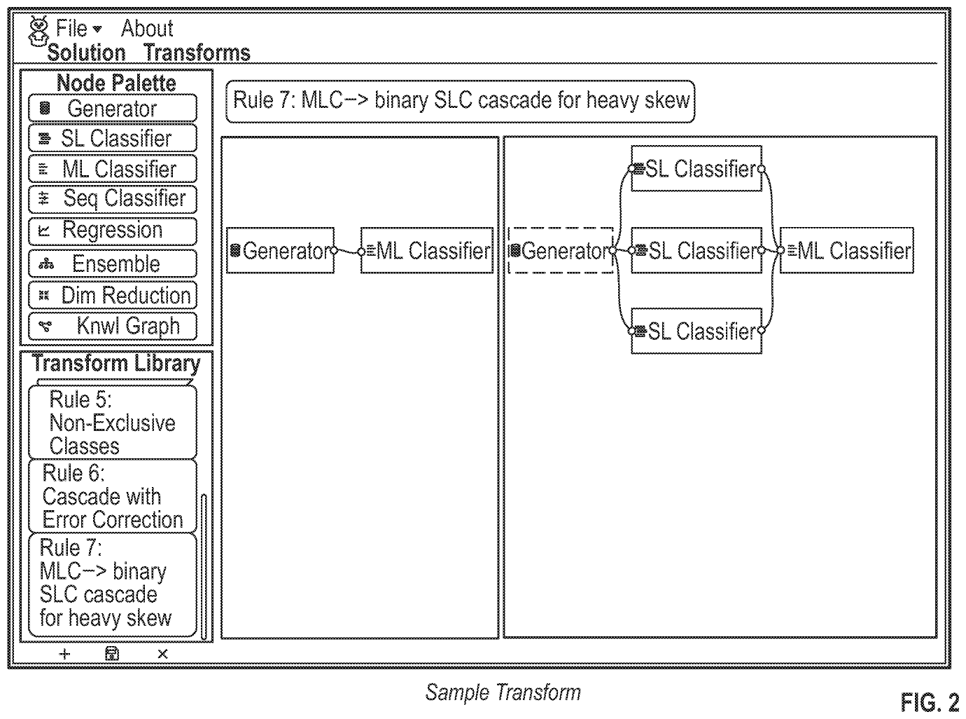

FIG. 2 is a draftsperson's rendition of a computer screenshot of Applicant's prototype implementation showing the result of a Transform. The source pattern (original subgraph) is represented as a subgraph on the left side of the vertical line in the main part of the screenshot, and the target pattern produced by the Transform is represented as a subgraph on the right side of the vertical line.

The example illustrated in FIG. 2 shows a Transform in which a single Multi-Label Classifier (accompanied by its source Generator) is transformed into a hierarchy of (binary) Single-Label Classifiers that pre-analyze the data before combining results with a Multi-Label Classifier that, in this case, shares the same output features as the source pattern. The purpose of this example transformation is to address the issue of heavy label skew within the Generator source data, which can degrade the performance of a Classifier if the source data were applied directly to the Classifier. After this Transform is performed, the new Transform then becomes available for use whenever a heavily skewed dataset is fed into a Multi-Label Classifier.

After rewriting a graph, either via manual editing or by applying a computer automated Transform application (software), the new version of the graph may be retained in a graph version control library. Different versions of graphs can then be compared against each other, for purposes of manually examining characteristics of different graphs, external prototyping and implementation, simulation (especially supported here by the completeness of the formalism), heuristic-driven analysis, and/or external analysis (such as applying prompt engineering to solution graphs in order to utilize large language models). These varied means of analysis and examination can then be compiled into a feedback log, to assist the user of the system in examining relative characteristics between and among graph versions.

Selected graph versions can be exported as human or machine readable designs, as code templates and scaffolds, or as fully generated training and inference code, to assist in the construction of future models.

New Transforms can be generated programmatically, and evaluated against test graphs, e.g., by using computer simulations in which the capabilities of the original graph are compared with the capabilities of a new graph that was produced by applying the new Transform. Transforms with useful properties can be retained in a reusable Transform Library, and those that do not exhibit improvements along desired parameters can be discarded. This allows automation of the Transform discovery process, removing the need for expert software designers to manually identify and catalog Transform patterns. These simulations may be conducted, for example, by using a large language model to generate datasets that adhere to a Generator's features, and by using nodes such as Classifiers with a zero-shot model.

The graphs and transforms illustrated in this patent application can be created and manipulated using conventional computer programming techniques. This computer programming can be implemented in the form of instructions contained on a computer readable medium. The term “computer readable medium” is to be taken to include a single medium or multiple media (e.g., a centralized or distributed database, and/or associated caches and servers) that store one or more sets of computer programming instructions. The term “computer readable medium” is accordingly be taken to include, but not be limited to, solid-state memories, optical media, and magnetic media. Such media can also include, without limitation, hard disks, floppy disks, flash memory cards, digital video disks, random access memory, read only memory, and the like.

### Advantageous Features of the Present Invention

The following advantageous features are inherent in the present invention:
1. The graphical formalism described above directly supports computer-driven analysis of a system architecture. Such analyses can include, without limitation, simulation, prototyping on real data, heuristic-driven analysis, and generative analysis via pretrained large language models (LLMs). Even with inexpensive mockups of data and models, relative characteristics can be estimated.
2. Alternative architectures and designs can be explored, helping to discover various means of achieving a given goal with differing levels of functional equivalency.
3. The formalism and implementation inherent in AutoSpec lends itself to socializing the design process. The design process is largely manual today, involving a small number of individuals exchanging manually-created documents and drawings (hard copy paper, whiteboards, or digital equivalents). The present invention enables system designers to have a record of feedback, decisions, and alternatives considered in a standardized way.
4. Knowledge and discoveries of patterns for system architecture adjustment can be captured as Transforms in a Transform library. This allows the knowledge of senior designers to be shared with others in an organization, becoming a powerful tool not only for designing a single system, but also for improving the process of designing future systems. AutoSpec gains in capability and power with every new Transform that is created.
5. Because all relevant aspects of the system architecture, including feedback and measurements, are captured in AutoSpec's formalism, an automated discovery process can propose and evaluate new Transforms. New Transforms can be simulated for their effect on existing or synthetic system design graphs, and expected behaviors of each Transform can be characterized. The Transform library grows itself automatically and organically.
6. Systems are simulated by AutoSpec at a high task level (meta level). This advantageously separates the specific concerns of implementation details (such as model parameterization or data throughput) from logical meta-level concerns.

The above description is included to illustrate the operation of preferred embodiments, and is not meant to limit the scope of the present invention. The scope of the invention is to be limited only by the following claims. From the above discussion, many variations will be apparent to one skilled in the art that would yet be encompassed by the spirit and scope of the present invention. For example, the terms “graphical formalism” and “graph” are used in this patent application in a non-limiting sense. These terms are not to be construed as being limited to just a lines-and-boxes visual user interface. For example, a custom programming language (e.g., a Domain Specific Language) can be used to represent these “graphs”, rather than a visual interface.

What is claimed is:

1. A graph for representing a computer system, said graph comprising a plurality of nodes and a plurality of edges connecting the nodes, wherein:
each node represents a computerized operation that produces or consumes at least one feature; and
each edge represents a set of features.

2. The graph of claim 1 wherein at least one operation is a machine learning operation.

3. The graph of claim 1 wherein each node represents at least one of a model, a data source, and a software component that manipulates or transforms feature sets.

4. The graph of claim 1 wherein each feature comprises a schematic definition of a dataset.

5. The graph of claim 1 wherein at least one node consumes inbound features.

6. The graph of claim 1 wherein each node is a classifier, a generator, a regressor, or a data sink.

7. The graph of claim 6 wherein a classifier is a node that consumes input features and produces a discrete category of output features.

8. The graph of claim 6 wherein a classifier comprises at least one of a deep neural network, a decision tree, a hard-coded set of if-then rules, a regular expression, and a predetermined algorithm.

9. The graph of claim 6 wherein a generator is a node that consumes no input features, and produces at least one output feature.

10. The graph of claim 6 wherein a generator comprises at least one of a data stream, an active database, an API interaction, and a static file.

11. The graph of claim 6 wherein a regressor consumes input features, and produces a continuous numerical output.

12. The graph of claim 1 wherein the graph is reconfigurable by a transform operation.

13. The graph of claim 12 wherein the transform operation is constrained by a user-selected equivalency guarantee regarding behavior and outputs of the computer system.

14. The graph of claim 12 wherein the transform operation is performed by a human user.

15. The graph of claim 12 wherein the transform operation is performed by a computer automated application.

16. The graph of claim 12 wherein the transform operation reconfigures the graph into a reconfigured graph, and the reconfigured graph is stored in a graph version control library.

17. The graph of claim 12 wherein the transform operation conditionally reconfigures the graph into a reconfigured graph based on a comparative analysis, such as a system simulation, assessing the relative functionality of the original and reconfigured graphs.

18. The graph of claim 17 wherein the transform operation is evaluated according to automated criteria, and the reconfigured graph is conditionally discarded or stored in a library of transform operations.

19. A computer implemented method for reconfiguring a graph representing a computer system, said graph comprising a plurality of nodes and a plurality of edges connecting the nodes, wherein each node represents a computerized operation that produces at least one output feature, and each edge represents sets of features, said method comprising applying a transform operation to the graph.

20. At least one computer readable medium containing computer programming instructions for reconfiguring a graph representing a computer system, said graph comprising a plurality of nodes and a plurality of edges connecting the nodes, wherein each node represents a computerized operation that produces at least one output feature, and each edge represents a set of features, said computer programming instructions comprising applying a transform operation to the graph.
